(19) United States
(12) Patent Application Publication
(10) Pub. No.: US 2015/0380708 A1
(43) Pub. Date: Dec. 31, 2015

(54) MULTILAYER POROUS FILM, SEPARATOR FOR NONAQUEOUS ELECTROLYTE SECONDARY BATTERY, AND NONAQUEOUS ELECTROLYTE SECONDARY BATTERY

(71) Applicant: MITSUBISHI PLASTICS, INC., Chiyoda-ku, Tokyo (JP)

(72) Inventors: Hiroto YAMADA, Ogaki-shi (JP); Tomoyuki NEMOTO, Nagahama-shi (JP)

(73) Assignee: Mitsubishi Plastics, Inc., Chiyoda-ku, Tokyo (JP)

(21) Appl. No.: 14/768,573

(22) PCT Filed: Dec. 25, 2014
(86) PCT No.: PCT/JP2014/084421

§ 371 Date: Aug. 18, 2015

(30) Foreign Application Priority Data
Jan. 7, 2014 (JP) 2014-000834

(51) Int. Cl. H01M 2/16

(52) U.S. Cl. CPC H01M 2/1686; H01M 2/1646; H01M 2/1653

(57) ABSTRACT

A multilayer porous film having, on at least one surface of a polyolefinic resin porous film, a coating layer that contains an alumina and a resin binder, wherein, when the alumina is heated at a heating rate of 10° C./min in thermogravimetric analysis, the mass of the alumina at 250° C. W₂₅₀ and the mass thereof at 400° C. W₄₀₀ satisfy the following relationship relative to the mass of the alumina at 25° C. W:

(W₂₅₀−W₄₀₀)/W≧0.00350

### TECHNICAL FIELD

The present invention relates to a multilayer porous film, and relates to a multilayer porous film for use in packaging, sanitary, animal husbandry, agricultural, architectural and medical applications, separator membranes, light diffusing plates and battery separators. The present invention also relates to a separator for nonaqueous electrolyte secondary batteries and a nonaqueous electrolyte secondary battery both using the multilayer porous film.

### BACKGROUND ART

Porous polymer bodies having many open micropores are used in various fields as separator membranes for use in ultrapure water production, purification of chemical solutions, and water treatment; waterproof moisture-permeable films for use in clothing, sanitary supplies, etc.; and battery separators for use in secondary batteries, etc.

Secondary batteries are widely used as power supplies for portable instruments, such as OA, FA, electric appliances for home use, communication appliances, etc. In particular, portable instruments using lithium ion secondary batteries are becoming widespread because, when mounted on such instruments, the lithium ion secondary batteries have high volumetric efficiency and therefore can reduce the size and the weight of the instruments. On the other hand, large-size secondary batteries are under research and development in many fields related to energy and environmental issues, including load-leveling, UPSs and electric vehicles, and applications of lithium ion secondary batteries that belong to one type of nonaqueous electrolyte secondary batteries are becoming widespread because of their large capacities, high output power, high voltage and high long-term storage stability.

Lithium ion secondary batteries are generally so designed as to have a highest working voltage falling in a range of from 4.1 to 4.2 V. Aqueous solutions are electrolyzed at such a high voltage and could not be used as electrolyte solutions. Consequently, so-called nonaqueous electrolytes, which contain organic solvents, are used as electrolyte solutions that can withstand high voltages. High-permittivity organic solvents, which can dissolve a larger amount of lithium ions, are used as solvents for nonaqueous electrolytes. Organic carbonate compounds, such as propylene carbonate, ethylene carbonate, etc., are mainly used as high-permittivity organic solvents. A highly-reactive electrolyte such as lithium hexafluorophosphate or the like is dissolved in a solvent and is used as a supporting electrolyte to serve as a lithium ion source in the solvent.

A lithium ion secondary battery comprises a separator arranged between a positive electrode and a negative electrode in order to prevent internal short-circuits. From the nature of the system, the separator is naturally required to have insulating properties. In addition, the separator must have a microporous structure in order to achieve high permeability for passage of lithium ions therethrough and to diffuse and retain an electrolyte solution therein. To satisfy these requirements, porous films are used for separators.

The recent tendency toward a rise in battery capacity has resulted in the increase in the importance in battery safety. The characteristics of battery separators that contribute to safety include shutdown characteristics (hereinafter referred to as “SD characteristics”). The SD characteristics have such a function that micropores of a porous film are closed at a high temperature in a range of approximately from 100° C. to 150° C. to thereby intercept ionic conduction in a battery and prevent a subsequent temperature rise in the battery. The lowest temperature at which micropores of a porous film are closed is referred to as a shutdown temperature (hereinafter referred to as “SD temperature”). Porous films to be used as battery separators need to have the SD characteristics.

However, because of recent increases in energy density and capacity of lithium ion secondary batteries, there have been accidents in which the ordinary SD characteristics could not sufficiently function so that the internal temperature of batteries may exceed over the melting point, approximately 130° C., of a polyethylene that is used as a material of battery separators, and as a result, this may cause thermal shrinkage and rupture of the separator and a short-circuit between electrodes, further resulting in ignition. Given the situation and in order to ensure battery safety, there is a demand for separators having higher heat resistance than that for the present SD characteristics.

To satisfy the requirement, a multilayer porous film has been proposed that comprises, as arranged on at least one surface of a polyolefinic resin porous film, a porous layer containing a metal oxide and a resin binder (PTLs 1 to 5). These documents say that the proposed method is extremely excellent in safety in that a coating film filled with a large amount of inorganic fine particles of α-alumina or the like is provided on a porous film and can therefore prevent short-circuits between electrodes even in an emergency of abnormal heating and continuous temperature increasing over the SD temperature.

### CITATION LIST

### Patent Literature

[PTL 1] JP-A 2004-227972

[PTL 2] JP-A 2008-186721

[PTL 3] WO2008/149986

[PTL 4] JP-A 2008-305783

[PTL 5] WO2012/023199

### SUMMARY OF INVENTION

### Technical Problem

However, inorganic particles of alumina or the like often undergo surface state change depending on some delicate difference in the firing condition and the storage condition thereof, and in preparing a dispersion thereof by dispersing the inorganic particles in a dispersion medium for forming a coating layer on a porous film, the viscosity of the resultant dispersion could not be stable, therefore providing a problem in that the productivity could not be stabilized. In a case where a multilayer porous film is produced using a dispersion that has an unstable viscosity, there occurs a phenomenon that the smoothness of the multilayer porous film is greatly worsened owing to the viscosity fluctuation of the dispersion. Such a film still has other problems in that not only the outward appearance thereof is not good but also the conveyability, that is, the “slidability” of the film is poor, and therefore in cutting the film into sheets or in piling up the resultant sheets, the handle ability of the film is extremely bad.

An object of the present invention is to solve the above-mentioned problems. In other words, it is an object of the present invention to improve the viscosity stability in producing a dispersion for forming a coating layer using alumina and to thereby provide a multilayer porous film having excellent smoothness in a case of forming a coating layer on a polyolefinic resin porous film using the resultant dispersion.

### Solution to Problem

The present inventors have assiduously studied taking the above-mentioned problems into consideration and, as a result, have found that the problems can be solved by producing a multilayer porous film using an alumina that has a weight reduction ratio falling within a specific range in heating it at a temperature falling within a specific range, and have completed the present invention.

Specifically, the present invention is as described below.

[1] A multilayer porous film having, on at least one surface of a polyolefinic resin porous film, a coating layer that contains an alumina and a resin binder, wherein, when the alumina is heated at a heating rate of 10° C./min in thermogravimetric analysis, the mass of the alumina at 250° C. W₂₅₀ and the mass thereof at 400° C. W₄₀₀ satisfy the following relationship relative to the mass of the alumina at 25° C. W:

(W₂₅₀−W₄₀₀)/W≧0.00350

[2] The multilayer porous film according to [1], wherein the content molar ratio of the water molecule to the aluminum oxide molecule in the crystal structure of the alumina (x in Al₂O₃.xH₂O) is less than 1.0.
[3] The multilayer porous film according to [1] or [2], wherein the alumina is an α-alumina.
[4] The multilayer porous film according to any of [1] to [3], wherein the resin binder is at least one selected from a group consisting of a polyvinyl alcohol, a polyvinylidene fluoride, a carboxymethyl cellulose, a polyacrylic acid and a polyacrylic acid derivative.
[5] The multilayer porous film according to any of [1] to [4], wherein in the coating layer, the alumina content relative to the total amount of the alumina and the resin binder is within a range of from 80% by mass to 99.9% by mass.
[6] The multilayer porous film according to any of [1] to [5], wherein the polyolefinic resin porous film contains a polypropylenic resin.
[7] The multilayer porous film according to any of [1] to [6], wherein the coating layer is formed on the polyolefinic resin porous film by applying a dispersion for forming the coating layer onto the film.
[8] The multilayer porous film according to [7], wherein the dispersion medium for the dispersion for forming the coating layer is a mixed dispersion medium of water and a lower alcohol having from 1 to 4 carbon atoms.
[9] A separator for nonaqueous electrolyte secondary batteries, using the multilayer porous film of any of [1] to [8].
[10] A nonaqueous electrolyte secondary battery using the separator for nonaqueous electrolyte secondary batteries of [9].

### Advantageous Effects of Invention

According to the present invention, the viscosity stability in producing a dispersion for forming a coating layer using an alumina can be increased, and therefore in a case of forming a coating layer on a polyolefinic resin porous film using the resultant dispersion, there can be obtained a multilayer porous film having excellent smoothness and, as a result, excellent in productivity and handleability and further heat resistance and vapor permeability, and in particular, capable of exhibiting excellent characteristics in use thereof as a separator for nonaqueous electrolyte secondary batteries.

### BRIEF DESCRIPTION OF DRAWINGS

FIG. 1 is a schematic cross-sectional view of a battery that houses therein a multilayer porous film of the present invention.

### DESCRIPTION OF EMBODIMENTS

Embodiments of the multilayer porous film, the separator for nonaqueous electrolyte secondary batteries and the nonaqueous electrolyte secondary battery of the present invention are described in detail hereinunder.

Unless otherwise specifically indicated in the present invention, the expression “main component” allows inclusion of any other component within a range not interfering with the function of the main component, and though the content ratio of the main component is not particularly specified, the main component is meant to be included in an amount of 50% by mass or more preferably 70% by mass or more, more preferably 90% by mass or more (including 100% by mass) in the composition.

Also unless otherwise specifically indicated, the expression “from X to Y” (where X and Y each are an arbitrary number) includes a meaning of “X or more and Y or less” and also a meaning of “preferably more than X” and a meaning of “preferably less than Y”.

### [Multilayer Porous Film]

The components constituting the multilayer porous film are described below.

### <Polyolefinic Resin Porous Film>

The polyolefinic resin for use for the polyolefinic resin porous film includes a homopolymer or a copolymer produced through polymerization of an α-olefin such as ethylene, propylene, 1-butene, 4-methyl-1-pentene, 1-hexene, etc. Two or more different types of those homopolymers or copolymers may be used as combined. Of those, preferred is use of a polypropylenic resin or a polyethylenic resin. In particular, from the viewpoint of maintaining the mechanical strength and the heat resistance and the like of the multilayer porous film of the present invention, preferred is use of a polypropylenic resin.

### (Polypropylenic Resin)

The polypropylenic resin for use in the present invention includes a homopropylene (propylene homopolymer) as well as a random copolymer or a block copolymer of propylene with an α-olefin such as ethylene, 1-butene, 1-pentene, 1-hexene, 1-heptene, 1-octene, 1-nonene, 1-decene or the like. Of those, more preferred for use herein is homopolypropylene from the viewpoint of maintaining the mechanical strength and the heat resistance and the like of the multilayer porous film of the present invention, preferred is use of a polypropylenic resin.

Of the polypropylenic resin, the isotactic pentad fraction (mmmm fraction) that indicates the stereoregularity thereof is preferably from 80 to 99%. More preferably, one having the fraction of from 83 to 98%, even more preferably from 85 to 97% is used here. When the isotactic pentad fraction is too low, then the mechanical strength of the film may lower. On the other hand, the upper limit of the isotactic pentad fraction is defined here as the upper limit that is industrially available at present, which, however, shall not apply to a case where any resin having a further higher regularity can be developed on the industrial level in future.

The isotactic pentad fraction (mmmm fraction) is meant to indicate the steric structure having a main chain of carbon-carbon bonds formed of arbitrary continuous five propylene units in which the five side chains of methyl groups are all positioned in the same direction with respect to the main chain, or the proportion of the structure. Signals in the methyl group region are assigned according to A. Zambelli et al. (Macromolecules 8, 687, (1975)).

The parameter M_{w}/Mₙ of the polypropylenic resin for use herein that indicates the molecular weight distribution thereof is preferably from 2.0 to 10.0, more preferably from 2.0 to 8.0, even more preferably from 2.0 to 6.0. A smaller ration of M_{w}/Mₙ means a narrower molecular weight distribution. M_{w}/Mₙ of less than 2.0 may result in poor extrusion moldability and make industrial production difficult. M_{w}/Mₙ of more than 10.0 may increase the amount of low-molecular-weight components in the resin, whereby the mechanical strength of the multilayer porous film is liable to be lowered.

M_{w}/Mₙ of the polypropylenic resin may be measured according to a method of GPC (gel permeation chromatography).

The density of the polypropylenic resin is preferably from 0.890 to 0.970 g/cm³, more preferably from 0.895 to 0.970 g/cm³, even more preferably from 0.900 to 0.970 g/cm³. The density of 0.890 g/cm³ or more could secure suitable SD characteristics. On the other hand, the density of 0.970 g/cm³ or less could also secure suitable SD characteristics and additionally could realize drawability of the film.

The density of the polypropylenic resin may be measured using a density gradient tube method according to JIS K7112 (1999).

Not specifically limited, the melt flow rate (MFR) of the polypropylenic resin is, in general, preferably from 0.5 to 15 g/10 min, more preferably from 1.0 to 10 g/10 min, even more preferably from 1.0 to 5 g/10 min. MFR of 0.5 g/10 min or more would make the resin has a high melt viscosity in molding and could secure sufficient productivity. On the other hand, MFR of 15 g/10 min or less could sufficiently secure the mechanical strength of the resultant multilayer porous film.

MFR of the polypropylenic resin may be measured under the condition of a temperature of 230° C. and a load of 2.16 kg according to JIS K7210 (1999).

The production method for the polypropylenic resin is not specifically limited, for which mentioned here are various known polymerization methods using known olefin polymerization catalysts, for example, a suspension polymerization method, a melt polymerization method, a bulk polymerization method or a vapor-phase polymerization method using a multi-site catalyst as typified by a Ziegler-Natta catalyst or using a single-site catalyst as typified by a metallocene catalyst, or a bulk polymerization method using a radical initiator.

Examples of the polypropylenic resin include commercially available products, such as trade names “Novatec PP” and “WINTEC” (both manufactured by Japan Polypropylene Corporation), “Notio” and “Tafmer XR” (both manufactured by Mitsui Chemicals, Inc.), “Zelas” and “Thermorun” (both manufactured by Mitsubishi Chemical Corp.), “Sumitomo Noblen” and “Tafthern” (both manufactured by Sumitomo Chemical Co., Ltd.), “Prime Polypro” and “Prime TPO” (both manufactured by Primer Polymer Co., Ltd.), “Adflex”, “Adsyl” and “HMS-PP (PF814)” (all manufactured by SunAlomer Ltd.), “Versify” and “Inspire” (both manufactured by The Dow Chemical Company), etc.

### (Polyethylenic Resin)

The polyethylenic resin for use in the present invention includes a low-density polyethylene, a linear low-density polyethylene, a linear ultra-low-density polyethylene, a middle-density polyethylene, a high-density polyethylene, and a copolymer comprising ethylene as a main component, or that is, a copolymer or a tercopolymer of ethylene with one or more comonomers selected from unsaturated compounds of an α-olefin having from 3 to 10 carbon atoms, such as propylene, 1-butene, 1-pentene, 1-hexene, 1-heptene, 1-octene, etc.; a vinyl ester such as vinyl acetate, vinyl propionate, etc.; an unsaturated carboxylate such as methyl acrylate, ethyl acrylate, methyl methacrylate, ethyl methacrylate, etc.; a conjugated diene and a nonconjugated diene, and also a mixed composition of those polymers. The ethylene unit content in the ethylenic polymer is generally more than 50% by mass.

Of those polyethylenic resins, preferred is at least one polyethylenic resin selected from a low-density polyethylene, a linear low-density polyethylene and a high-density polyethylene, and more preferred is a high-density polyethylene.

The density of the polyethylenic resin is preferably from 0.910 to 0.970 g/cm³, more preferably from 0.930 to 0.970 g/cm³, even more preferably from 0.940 to 0.970 g/cm³. The density of 0.910 g/cm³ or more is preferred since suitable SD characteristics are secured. On the other hand, the density of 0.970 g/cm³ or less is also preferred since not only suitable SD characteristics are exhibited but also the drawability is exhibited.

The density of the polyethylenic resin may be measured using a density gradient tube method according to JIS K7112 (1999).

Not specifically limited, the melt flow rate (MFR) of the polyethylenic resin is, in general, preferably from 0.03 to 30 g/10 min, more preferably from 0.3 to 10 g/10 min. MFR of 0.03 g/10 min or more is preferred as capable of making the resin have a sufficiently low melt viscosity in molding and therefore excellent in productivity. On the other hand, MFR of 30 g/10 min or less is also preferred as capable of making the film have a sufficient mechanical strength.

MFR of the polyethylenic resin may be measured under the condition of a temperature of 190° C. and a load of 2.16 kg according to JIS K7210 (1999).

The production method for the polyethylenic resin is not specifically limited, for which mentioned here are various known polymerization methods using known olefin polymerization catalysts, for example, a polymerization method using a multi-site catalyst as typified by a Ziegler-Natta catalyst or using a single-site catalyst as typified by a metallocene catalyst. The polymerization method for the polyethylenic resin includes one step polymerization, two-step polymerization, multistep polymerization in more than two steps, etc., and polyethylenic resins according to any method are employable here.

### (Other Components)

In the present invention, additives that are generally incorporated in resin compositions may be suitably added to the polyolefinic resin porous film, in addition to the above-mentioned resin added thereto, within a range not significantly detracting from the advantageous effects of the present invention. The additives include recycled resin from trimming loss of deckle edges, etc., inorganic particles such as silica, talc, kaolin, calcium carbonate, etc., pigment such as carbon black, etc., and other additives such as flame retardant, weather stabilizer, heat stabilizer, antistatic agent, melt viscosity improver, crosslinking agent, lubricant, nucleating agent, plasticizer, antiaging agent, antioxidant, light stabilizer, UV absorbent, neutralizing agent, defogger, antiblocking agent, slip agent, colorant and the like, which are added for the purpose of improving and regulating the moldability, the productivity and various physical properties of the polyolefinic resin porous film.

In addition, for promoting cell opening and for imparting moldability, various resins and low-molecular compounds such as wax or the like may also be added to the film within a range not significantly detracting from the advantageous effects of the present invention.

### (Layer Configuration of Polyolefinic Resin Porous Film)

In the present invention, the polyolefinic resin porous film may be a single-layer one or a multilayer one, and is not specifically limited. Above all, preferred is a single-layer film of the polyolefinic resin-containing layer (hereinafter this may be referred to as “layer A”), or a multilayer film that comprises the layer A and any other layer (hereinafter this may be referred to as “layer B”) within a range not interfering with the function of the layer A. The layer B may be a layer that contains a polyolefinic resin differing from the layer A.

Concretely, there are exemplified a two-layer configuration of a laminate of layer A/layer B, a three-layer configuration of a laminate of layer A/layer B/layer A, layer B/layer A/layer B, etc. In addition, the film of the present may have a three-type three-layer configuration that comprises a combination with any other layer having any other function. In this case, the order of lamination with any other layer having any other function is not specifically limited. Further, the number of the layers may be increased in any desired manner to be 4 layers, 5 layers, 6 layers or 7 layers.

### (Production Method for Polyolefinic Resin Porous Film)

For the production method for the polyolefinic resin porous film, any production method for heretofore-known porous films may be favorably employed here with no specific limitation thereon. In general, preferably employed is a method that comprises preparing a nonporous film of a precursor for forming the polyolefinic resin porous film, and processing the precursor to make it have pores thereby providing the intended polyolefinic resin porous film.

The production method for the nonporous film of a precursor for the polyolefinic resin porous film is not specifically limited, for which any known method is employable. For example, there is mentioned a method of melting a thermoplastic resin composition and extruding it out through a T-die using an extruder, and cooling and solidifying it on a cast roll. In addition, also employable here is a method of cutting open a tube prepared according to a tubular method to give a flat film.

The method for processing the nonporous film to be a porous film is not specifically limited, for which employable is any known method such as a monoaxial or more multiaxial stretching and pore-forming method on a wet-process, a monoaxial or more multiaxial stretching and pore-forming method on a dry-process, etc. For the stretching method, employable is any of a roll stretching method, a rolling method, a tenter stretching method, a simultaneous biaxial stretching method, etc. One alone or two or more of these methods may be combined for monoaxial stretching or biaxial stretching. Above all, preferred is a sequential biaxial stretching method from the viewpoint of porous structure control. If desired, also employable here is a method where the plasticizer contained in the resin composition is extruded out to dry the film before and after stretching. Further, for the purpose of improving the dimensional stability thereof, the film may be heat-treated or relaxed after stretching.

In the case of using a polypropylenic resin for the polyolefinic resin porous film, preferably, so-called β-crystals are formed in the nonporous film. Forming β-crystals in the nonporous film makes it easy to form micropores in the film merely by stretching even in a case where an additive such as a filler or the like is not used, and as a result, a polyolefinic resin porous film having excellent vapor permeability characteristics can be obtained.

The method for forming β-crystals in the nonporous film of a polypropylenic resin includes a method in which a substance to promote the formation of α-crystals of the polypropylenic resin is not added, a method of adding a polypropylene that has been processed to generate an peroxide radical as described in Japanese Patent No. 3739481, a method of adding a β-crystal nucleating agent to the composition, etc.

### (β-Crystal Nucleating Agent)

The β-crystal nucleating agent for use in the present invention includes those mentioned below. Not specifically limited, any one capable of enhancing the formation and growth of β-crystals of a polypropylenic resin is employable here, and two or more such agents may be used as combined.

The β-crystal nucleating agent includes, for example, amide compounds; tetroxaspiro compounds; quinacridones; nanoscale-size iron oxide; alkali or alkaline earth metal carboxylates as typified by potassium 1,2-hydroxystearate, magnesium benzoate, magnesium succinate, magnesium phthalate, etc.; aromatic sulfonic acid compounds as typified by sodium benzenesulfonate, sodium naphthalenesulfonate, etc.; di or triesters of di or tribasic carboxylates; phthalocyanine pigments as typified by phthalocyanine blue, etc.; two-component compounds comprising a component of an organic dibasic acid and a component of an oxide, hydroxide or a salt of a metal of Group 2 of the Periodic Table; compositions comprising a cyclic phosphorus compound and a magnesium compound, etc. Specific types of other nucleating agents are described in JP-A 2003-306585, JP-A 8-144122 and JP-A 9-194650.

Commercially-available β-crystal nucleating agents include a β-crystal nucleating agent “Njstar NU-100” manufactured by New Japan Chemical Co., Ltd. Specific examples of polypropylenic resins to which a β-crystal nucleating agent is added include a polypropylene “Bepol B-022SP” manufactured by Aristech Co, Ltd., a polypropylene “Beta(β)-PP BE60-7032” manufactured by Borealis Co., Ltd., a polypropylene “BNX BETAPP-LN” manufactured by Mayzo Co., Ltd., etc.

The proportion of the β-crystal nucleating agent to be added to the polypropylenic resin must be suitably controlled depending on the type of the β-crystal nucleating agent, the composition of polypropylenic resin or the like. Preferably, the proportion is from 0.0001 to 5 parts by mass relative to 100 parts by mass of the polypropylenic resin to constitute the polyolefinic resin porous film, more preferably from 0.001 to 3 parts by mass, even more preferably from 0.01 to 1 part by mass.

When the proportion of the β-crystal nucleating agent is 0.0001 parts by mass or more relative to 100 parts by mass of the polypropylenic resin, it is possible to sufficiently form and grow β-crystals of the polypropylenic resin in production thereof, and in use as a separator for nonaqueous electrolyte secondary batteries, the resin film can secure sufficient β-crystal activity of the resin and can therefore realize the desired vapor permeability performance. On the other hand, the proportion of the β-crystal nucleating agent of being 5 parts by mass or less relative to 100 parts by mass of the polypropylenic resin is economically advantageous and provides another advantage that the β-crystal nucleating agent would not bleed out on the surface of the polyolefinic resin porous film.

In the present invention, the production method for the polyolefinic resin porous film as a multilayered film is roughly classified into the following three types depending on the sequence of pore formation and multilayer formation, etc.

(i) A method comprising forming pores in each layer, and laminating or adhering the resultant porous layers using an adhesive or the like to give a multilayer film.

(ii) A method comprising layering the constituent layers to give a multilayer nonporous film, and then forming pores in the nonporous film.

(iii) A method comprising forming pores in any one of the constituent layers, and layered with another nonporous film to give a multilayer porous film.

In the present invention, preferred is the method (ii) from the viewpoint of the simplified process and of the productivity of the film. In particular, for securing the interlayer adhesion between two layers, especially preferred is a method that comprises preparing a multilayer nonporous film through coextrusion and then forming pores in the film.

Preferably, the thickness of the polyolefinic resin porous film is from 5 to 100 μm, more preferably from 8 to 50 μm, even more preferably from 10 to 30 μm. The thickness of the polyolefinic resin porous film of being 5 μm or more realizes the substantially necessary electric insulation in use of the multilayer porous film of the present invention as a separator for nonaqueous electrolyte secondary batteries. For example, even when some great force is given to the projections of electrodes, the separator is hardly broken through to result in short-circuits and is therefore excellent in safety. On the other hand, the thickness of the polyolefinic resin porous film of being 100 μm or less can reduce the electric resistance in use of the multilayer porous film of the present invention as a separator for nonaqueous electrolyte secondary batteries, and therefore can fully secure battery performance.

### <Coating Layer>

The multilayer porous film of the present invention has, on at least one surface of a polyolefinic resin porous film, a coating layer that contains an alumina and a resin binder.

### (Alumina)

The alumina for use in the present invention is namely a crystal of aluminum oxide (Al₂O₃) molecules, and is generally produced through firing of an aluminum hydroxide (Al(OH)₃) (Bayer process) or heat treatment of an aluminum alkoxide gel (alkoxide process), etc. The alumina to be obtained according to these methods includes α-alumina, γ-alumina, θ-alumina, κ-alumina, pseudo-boehmite, etc., as classified depending on the transition mode thereof. Transition means the change in the crystal morphology in a process of purification that starts from a starting substance to be purified up to a single crystal of the resultant aluminum oxide, and α-alumina is substantially a single crystal of aluminum oxide. On the other hand, γ-alumina, θ-alumina, κ-alumina, pseudo-boehmite and the like each have a structure that contains slight water molecules in the crystal structure of aluminum oxide (Al₂O₃.xH₂O; 0<x<1.0), or that is, in the form of a hydrate. Further, an aluminum oxide compound that contains a further larger amount of water molecules in the crystal structure thereof than in γ-alumina or the like is referred to as boehmite, and the content of the water molecules relative to aluminum oxide in the crystal structure thereof is, as a ratio by mol thereof, x, from 1.0 to 1.5.

In the present invention, it is desirable that the content molar ratio x of the water molecule to the aluminum oxide molecule in the crystal structure is as small as possible, from the viewpoint that the mass reduction of alumina in thermogravimetric analysis to be mentioned below is made to fall within a specified range and that the viscosity stability of the dispersion for forming the coating layer is enhanced, and from the viewpoint that the alumina is chemically inactive when the film is incorporated in a nonaqueous electrolyte secondary battery as a separator therein. Alpha-alumina that is a single crystal of aluminum oxide is especially preferred here. More concretely, the content molar ratio x of the water molecule to the aluminum oxide molecule in the crystal structure is preferably less than 1.0, more preferably 0.5 or less, even more preferably 0.1 or less, still more preferably 0.01 or less, and most preferably, substantially x=0.

In the present invention, it is important that, when the alumina is heated at a heating rate of 10° C./min in thermogravimetric analysis, the mass of the alumina at 250° C. W₂₅₀ and the mass thereof at 400° C. W₄₀₀ satisfy the following relationship relative to the mass of the alumina at 25° C. W:

(W₂₅₀−W₄₀₀)/W≧0.00350

It is presumed that the active hydroxyl group on the surface of alumina would participate in the mass reduction of the alumina in a range of from 250° C. to 400° C., and the value of (W₂₅₀−W₄₀₀)/W of being 0.00350 or more provides an effect of extremely increasing the viscosity stability of the dispersion for forming a coating layer to be mentioned below. However, it could not be always said that the viscosity stability would be caused by mere water absorbability of alumina, and the details of the technical relationship between the value of (W₂₅₀−W₄₀₀)/W and the viscosity stability are not clarified.

The lower limit of the value (W₂₅₀−W₄₀₀)/W is preferably 0.00360 or more, more preferably 0.00370 or more. On the other hand, the upper limit of the value (W₂₅₀−W₄₀₀)/W is not specifically limited. In general, the value is preferably 0.0500 or less, more preferably 0.0100 or less, even more preferably 0.00500 or less. The value (W₂₅₀−W₄₀₀)/W of being 0.0500 or less is preferred because, when the multilayer porous film of the present invention is used as a separator for nonaqueous electrolyte secondary batteries and incorporated in a battery, a risk of foam formation could be reduced.

In the multilayer porous film of the present invention, the alumina that satisfies the above-mentioned requirement may be suitably selected and used. Alumina not satisfying the requirement may be treated, for example, under a high-temperature high-humidity condition to be converted into alumina satisfying the requirement, and the resultant alumina may be used in the multilayer porous film of the present invention. As the treatment condition in the case, preferably the temperature is from 60 to 100° C. and the relative humidity is from 50 to 100%, and more preferably the temperature is from 70 to 100° C. and the relative humidity is from 60 to 90%. The treatment time may be suitably selected from a range in which alumina satisfying the above requirement can be obtained.

The lower limit of the mean particle size of the alumina is preferably 0.01 μm or more, more preferably 0.1 μm or more, even more preferably 0.2 μm or more. On the other hand, the upper limit is preferably 3.0 μm or less, more preferably 1.5 μm or less, even more preferably 1.0 μm or less. The mean particle size of 0.01 μm or more is preferred because the multilayer porous film of the present invention can exhibit sufficient heat resistance. The mean particle size of 3.0 μm or less is also preferred from the viewpoint that the alumina dispersibility in the coating layer is enhanced.

In the present embodiment, “mean particle size of alumina” is calculated, for example, using an image analyzer, in which the alumina is projected in two directions of a vertical direction and a horizontal direction, the minor diameter and the major diameter of the two-dimensional projected image are read in each direction, the found data are averaged to give the mean particle size of the analyzed alumina.

Preferably, the specific surface area of the alumina is 5 m²/g or more and less than 15 m²/g. The specific surface area of 5 m²/g or more is preferred because, when the multilayer porous film of the present invention is incorporated as a separator in a nonaqueous electrolyte secondary battery, the electrolytic solution can penetrate through the separator rapidly and therefore the battery productivity is bettered. The specific surface area of less than 15 m²/g is also preferred because, when the multilayer porous film of the present invention is incorporated as a separator in a nonaqueous electrolyte secondary battery, the components of the electrolytic solution can be prevented from being adsorbed by the separator. More concretely, the specific surface area is more preferably 5 m²/g or more and 13 m²/g or less, even more preferably 5 m²/g or more and 11 m²/g or less.

In the present embodiment, “specific surface area of alumina” is a value as measured according to a constant-volume gas adsorption method.

The dispersion for forming a coating layer that uses the above-mentioned alumina is excellent in viscosity stability. As described below, the alumina is mixed with isopropyl alcohol and water, and then processed in a bead mill to prepare a dispersion. Using a B-type viscometer (“TVB10H” manufactured by Toki Sangyo Co., Ltd.), the viscosity of the dispersion is measured at a peripheral speed of 100 rpm. The viscosity η₁ of the dispersion after statically left for 1 hour, and the viscosity η₇₂ thereof after statically left for 72 hours are measured, and the upper limit of the ratio of η₇₂/η₁ is preferably less than 10, more preferably less than 5, even more preferably less than 3, still more preferably less than 1. The lower limit of the ratio is preferably 0.1 or more, more preferably 0.2 or more, even more preferably 0.3 or more.

In addition, the value η₇₂ is preferably within a range of from 10 to 3000 mPa·s, more preferably within a range of from 15 to 2500 mPa·s, even more preferably within a range of from 20 to 2000 mPa·s, still more preferably within a range of from 20 to 1500 mPa·s, yet still more preferably within a range of from 20 to 1000 mPa·s.

The value η₇₂/η₁ and the value η₇₂ each falling within the above-mentioned range are preferred because the coating layer-forming dispersion is excellent in long-term stability and is excellent in productivity (coatability) in applying the dispersion to the above-mentioned polyolefinic resin porous film to form thereon a coating layer.

### (Resin Binder)

Not specifically limited, the resin binder for use in the present invention may be any one that is effective for favorably bonding the alumina and the polyolefinic resin porous film and is chemically stable, and is stable to an organic electrolytic solution in a case where the multilayer porous film is used as a separator for nonaqueous electrolyte secondary batteries. Concretely, the resin binder includes polyethers, polyamides, polyimides, polyamideimides, polyaramids, polyoxyethylenes, ethylene-vinyl acetate copolymers (in which the vinyl acetate-derived structural unit is from 0 to 20 mol %), ethylene-acrylic acid copolymers such as ethylene-ethyl acrylate copolymers, etc., polyvinylidene fluorides, polyvinylidene fluoride-hexafluoropropylenes, polyvinylidene fluoride-trichloroethylenes, polytetrafluoroethylenes, fluororubbers, styrene-butadiene rubbers, nitrile-butadiene rubbers, polybutadiene rubbers, polyacrylonitriles, polyacrylic acids and derivatives thereof, polymethacrylic acids and derivatives thereof, carboxymethyl celluloses, hydroxyethyl celluloses, cyanoethyl celluloses, polyvinyl alcohols, cyanoethyl-polyvinyl alcohols, polyvinyl butyrals, polyvinyl pyrrolidones, poly-N-vinylacetamides, crosslinked acrylic resins, polyurethanes, epoxy resins, maleic acid-modified polyolefins, etc. One alone or two or more types of these resin binders may be used here either singly or as combined. Of those resin binders, preferred are polyoxyethylenes, polyvinyl alcohols, polyvinylidene fluorides, polyvinyl pyrrolidones, polyacrylonitrile resins, styrene-butadiene rubbers, carboxymethyl celluloses, polyacrylic acid and derivatives thereof and maleic acid-modified polyolefins, as relatively stable in water; and more preferred is at least one selected from a group consisting of polyvinyl alcohols, polyvinylidene fluorides, carboxymethyl celluloses, polyacrylic acids and polyacrylic acid derivatives.

In the coating layer, the alumina content relative to the total amount of the alumina and the resin binder is preferably within a range of from 80% by mass to 99.9% by mass. More preferably, the alumina content is 92% by mass or more, even more preferably 95% by mass or more, still more preferably 98% by mass or more. Having the alumina content that falls within the range, the coating layer secures excellent vapor permeability and binding capability.

### (Acid Component)

Preferably, the coating layer-forming dispersion for use in forming the coating layer in the present invention contains an acid component. The acid component may remain as an acid itself in the coating layer in the multilayer porous film of the present invention, or may remain therein as a salt formed through reaction with an alkaline impurity in the coating layer. Adding an acid component is effective for improving the uniformity of the coating layer.

Preferably, the acid component has a first acid dissociation constant (pKₐ₁) in an aqueous diluent solution thereof at 25° C. of 5 or less, but does not have or has a second acid dissociation constant (pKₐ₂) of 7 or more. Examples of the acid component having such characteristics include lower primary carboxylic acids such as formic acid, acetic acid, propionic acid, acrylic acid, etc.; nitro acid such as nitric acid, nitrous acid, etc.; halogenoxo acids such as perchloric acid, hypochlorous acid, etc.; halide ions of hydrochloric acid, hydrofluoric acid, hydrobromic acid, etc.; phosphoric acid, salicylic acid, glycolic acid, lactic acid, ascorbic acid, erythorbic acid, etc. Of those, preferred are formic acid, acetic acid, nitric acid, hydrochloric acid and phosphoric acid, from the viewpoint that even a small amount of the acid can readily lower the pH of the dispersion and from the viewpoint of the availability and the stability of the acid. The acid component satisfying the above-mentioned condition is effective for preventing alumina from aggregating and for prolonging the pot life of the coating layer-forming dispersion.

Preferably, the coating layer-forming dispersion for use in forming the coating layer in the present invention contains the acid component in an amount of from 10 ppm by mass to 10000 ppm by mass. The content of the acid component is more preferably from 30 ppm by mass to 9000 ppm by mass, even more preferably from 50 ppm by mass to 8000 ppm by mass.

The content of 10 ppm by mass or more is preferred as effective for forming a coating film excellent in uniformity. The content of 10000 ppm by mass is also preferred as not having any negative influence on the performance of nonaqueous electrolyte secondary batteries.

### (Formation Method for Coating Layer)

The formation method for the coating layer in the multilayer porous film of the present invention includes a coextrusion method, a lamination method, a coating method such as a coating and drying method, etc. In view of continuous production, preferably, the layer is formed according to a coating method. Specifically, it is desirable that the coating layer-forming dispersion is applied onto the surface of the polyolefinic resin porous film to form a coating layer thereon.

In the case of forming a coating layer according to a coating method, the dispersion medium for the coating layer-forming dispersion is preferably a solvent capable of suitably uniformly and stably dissolving or dispersing therein alumina and a resin binder. The solvent of the type includes, for example, N-methylpyrrolidone, N,N-dimethylformamide, N,N-dimethylacetamide, water, dioxane, acetonitrile, lower alcohols, glycols, glycerin, lactates, etc. Above all, from the viewpoint of cost reduction and environmental load reduction, the dispersion medium preferably contains a lower alcohol having from 1 to 4 carbon atoms. The lower alcohol is preferably a monoalcohol having from 1 to 4 carbon atoms, and is more preferably at least one selected from methanol, ethanol and isopropyl alcohol. One or more of these may be used here either singly or as combined.

Of the above, the dispersion medium is preferably a mixed dispersion medium of water and a lower alcohol having from 1 to 4 carbon atoms, more preferably a mixed dispersion medium of water and a monoalcohol having from 1 to 4 carbon atoms, and even more preferably a mixed dispersion medium of water and isopropyl alcohol.

The content of the lower alcohol having from 1 to 4 carbon atoms in the dispersion medium is preferably within a range of 1% by mass or more, more preferably 5% by mass or more, and is preferably 20% by mass or less, more preferably 15% by mass or less.

As a method of dissolving or dispersing the above-mentioned alumina and the above-mentioned resin binder in a dispersion medium, for example, there are mentioned a mechanical stirring method using a ball mill, a bead mill, a planetary ball mill, a shaking ball mill, a sand mill, a colloid mill, an attritor, a roll mill, a high-speed dispersion impeller, a disperser, a homogenizer, a high-speed impact mill, an ultrasonic disperser, a stirring blade or the like, etc.

In dispersing the alumina and the resin binder in a dispersion medium to prepare a coating layer-forming dispersion, a dispersion aid, a stabilizer, a thickener or the like may be added thereto before and after preparation of the dispersion, for the purpose of improving the stability of the dispersion and optimizing the viscosity thereof.

The step of applying the coating layer-forming dispersion onto the surface of the polyolefinic resin porous film is not specifically limited. Specifically, the coating layer-forming dispersion may be applied thereonto after extrusion and before stretching in the process of forming the polyolefinic resin porous film, or may be applied after the longitudinal stretching step or after the lateral stretching step in the process.

Not specifically limited, the coating mode in the coating step may be any one capable of realizing the necessary layer thickness and coating area. The coating method includes, for example, a gravure coater method, a small-size gravure coater method, a reverse roll coater method, a transfer roll coater method, a kiss coater method, a dip coater method, a knife coater method, an air doctor coater method, a blade coater method, a rod coater method, a squeeze coater method, a cast coater method, a die coater method, a screen printing method, a spray coating method, etc.

The coating layer-forming dispersion may be applied onto one surface alone or both surfaces of the polyolefinic resin porous film in accordance with the use thereof. Specifically, in the multilayer porous film of the present invention, the coating layer may be formed on one surface alone or both surfaces of the polyolefinic resin porous film.

As the method for removing the dispersion medium after coating with the coating layer-forming dispersion, any method is employable with no specific limitation thereon so far as the method does not have any negative influence on the polyolefinic resin porous film. As the method for removing the dispersion medium includes, for example, there are mentioned a method of drying the polyolefinic resin porous film at a temperature not higher than the melting point thereof while the film is kept fixed, a method for drying the film at a low temperature and under reduced pressure, a method that comprises immersing the coated film in a poor solvent relative to the resin binder to thereby solidify the resin binder and, at the same time, extract out the solvent, etc.

### <Shape and Physical Properties of Multilayer Porous Film>

The thickness of the multilayer porous film of the present invention is preferably from 5 to 100 μm. More preferably, the thickness of the multilayer porous film of the present invention is from 8 to 50 μm, even more preferably from 10 to 30 μm. In a case where the film is used as a separator for nonaqueous electrolyte secondary batteries and when the thickness of the film is 5 μm or more, the film can realize substantially necessary electric insulation performance, and in the case, for example, even when any large force is given to the projections of electrodes, the film used as the separator for nonaqueous electrolyte secondary batteries would not be broken through to bring about short-circuits, or that is, the battery having the film serving as the separator therein could be excellent in safety. In addition, the thickness of being 100 μm or less can reduce the electric resistance of the multilayer porous film, and therefore can sufficiently secure the battery performance.

The thickness of the coating layer is preferably 0.5 μm or more, more preferably 1 μm or more, even more preferably 2 μm or more, still more preferably 3 μm or more, from the viewpoint of the heat resistance of the film. On the other hand, from the viewpoint of the open cellular morphology thereof, the upper limit of the thickness of the coating layer is preferably 90 μm or less, more preferably 50 μm or less, even more preferably 30 μm or less, still more preferably 10 μm or less.

In the multilayer porous film of the present invention, the porosity is preferably 30% or more, more preferably 35% or more, even more preferably 40% or more. The multilayer porous film having a porosity of 30% or more could secure the open cellular morphology thereof and may be therefore excellent in vapor permeability characteristics.

On the other hand, the upper limit of the porosity is preferably 70% or less, more preferably 65% or less, even more preferably 60% or less. The multilayer porous film having a porosity of 70% or less could sufficiently secure the strength thereof, and the porosity range is preferred from the viewpoint of the handleability of the film.

The vapor permeability of the multilayer porous film of the present invention is preferably 1000 sec/100 mL or less, more preferably from 10 to 800 sec/100 mL, even more preferably from 50 to 500 sec/100 mL, still more preferably from 50 to 300 sec/100 mL. The multilayer porous film having a vapor permeability of 1000 sec/100 mL or less means that the film realizes open cellular morphology and is excellent in vapor permeation performance.

The vapor permeability indicates the difficulty of air passing through the film in the thickness direction of the film, and is concretely expressed as the time (second) needed by 100 mL of air to pass through the film. Accordingly, air can pass more easily through the film having a smaller vapor permeability value, but could more hardly pass through the film having a larger vapor permeability value. In other words, the film having a smaller value means that the open cellular performance of the film in the thickness direction thereof is better, while the film having a larger value means that the open cellular performance of the film in the thickness direction thereof is worse. The open cellular performance indicates the degree of open cellular morphology of the film in the thickness direction thereof. The multilayer porous film of the present invention having a lower vapor permeability can be used in various applications. For example, in a case where the film is used as a separator for nonaqueous electrolyte secondary batteries, the low vapor permeability of the film means that lithium ions could more easily move in the film, and the property of the film is favorable as excellent in battery performance.

The vapor permeability of the multilayer porous film can be measured according to the method described in the section of Examples to be given below.

In use as a separator for batteries, the multilayer porous film of the present invention preferably has SD characteristics. Concretely, it is desirable that the vapor permeability of the film after heated at 135° C. for 5 seconds is 10000 sec/100 mL or more, more preferably 25000 sec/100 mL or more, even more preferably 50000 sec/100 mL or more. The vapor permeability of the film after heated at 135° C. for 5 seconds of being 10000 sec/100 mL or more realizes rapid closing of the open pores in the film in an emergency of abnormal heating to shut off current flowing, and therefore troubles of battery rupture and the like can be thereby evaded.

The shrinkage of the multilayer porous film of the present invention at 150° C. is preferably less than 10% in both the longitudinal direction and the lateral direction thereof, more preferably less than 9%, even more preferably less than 8%. The shrinkage at 150° C. of being less than 10% suggests that the film secures good dimensional stability even in abnormal heating over the SD temperature thereof and therefore has heat resistance. The film of the type can be prevented from being broken under heat and can therefore have an elevated internal short-circuiting temperature. Not specifically limited, the lower limit of the shrinkage is preferably 0% or more.

The shrinkage of the multilayer porous film may be measured according to the method described in the section of Examples to be given below.

In the multilayer porous film of the present invention, it is an important effect to improve the surface smoothness of the coating layer. The surface smoothness may be evaluated by the degree of roughness to be measured according to the method described in the section of Examples to be given below. The film having a smaller degree of roughness may be more excellent in surface smoothness. The degree of roughness is preferably less than 100 projections/mm² from the viewpoint of evading film conveyance troubles and reducing appearance failures. More preferably, the degree of roughness is less than 80 projections/mm². Not specifically limited, the lower limit is ideally 0 projection/mm² or more, but is, in fact, preferably 10⁻¹⁰ projections/mm² or more.

### [Nonaqueous Electrolyte Secondary Battery]

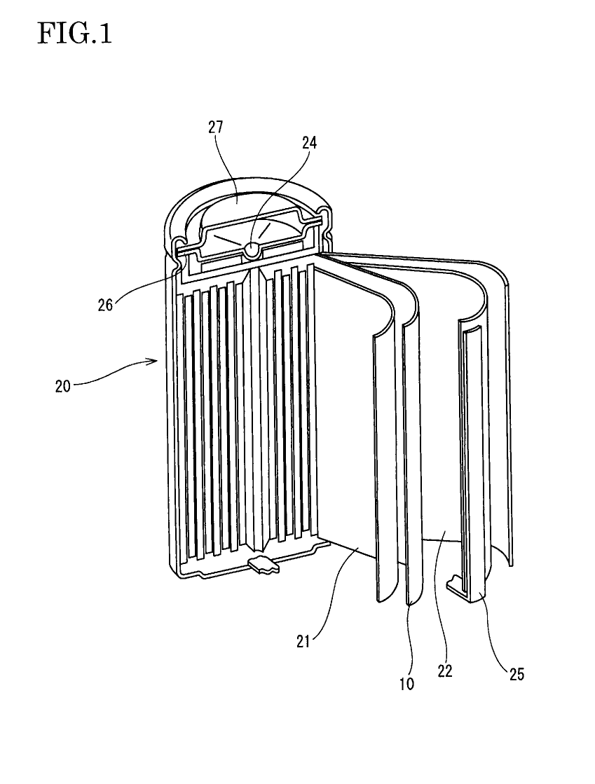

Next described is a nonaqueous electrolyte secondary battery that houses the multilayer porous film of the present invention as a battery separator therein, with reference to FIG. 1.

Both electrodes of a positive electrode sheet 21 and a negative electrode sheet 22 are spirally wound up to be layered on each other via a battery separator 10 put therebetween, and the outer side thereof is fixed with a winding stopper tape to give a wound body.

The winding step is described in detail. One end of the battery separator is led to pass through the slit part of a pin, and the pin is rotated a little so that one end of the battery separator is wound around the pin. In this stage, the surface of the pin is kept in contact with the coating layer of the battery separator. Subsequently, a positive electrode and a negative electrode are so arranged as to sandwich the battery separator therebetween, and the pin is rotated with a winding tool so that the positive and negative electrodes and the battery separator are wound up. After the winding, the pin is drawn off from the wound body.

The wound body in which the positive electrode sheet 21, the battery separator 10 and the negative electrode sheet 22 have been integrally wound up is housed in a bottomed cylindrical battery case, and welded to positive electrode and negative electrode leads 24 and 25. Next, an electrolyte is injected into the battery can, and after the electrolyte has fully penetrated to the battery separator 10 and others, the opening of the battery can is sealed up with a positive electrode cap 27 fitted to the peripheral edge of the opening via a gasket 26. With that, the battery is pre-charged and aged to produce a cylindrical nonaqueous electrolyte secondary battery 20.

The electrolytic solution used here comprises a lithium salt as an electrolyte and is prepared by dissolving the electrolyte in an organic solvent. The organic solvent is not specifically limited. For example, as the organic solvent, there are mentioned esters such as propylene carbonate, ethylene carbonate, butylene carbonate, γ-butyrolactone, γ-valerolactone, dimethyl carbonate, methyl propionate, butyl acetate, etc.; nitriles such as acetonitrile, etc.; ethers such as 1,2-dimethoxyethane, 1,2-dimethoxymethane, dimethoxypropane, 1,3-dioxolan, tetrahydrofuran, 2-methyltetrahydrofuran, 4-methyl-1,3-dioxolane, etc.; sulfolanes, etc. One alone or two or more of these may be used here either singly or as combined. Above all, preferred is an electrolytic solution prepared by dissolving lithium hexafluorophosphate (LiPF₆) in a mixed solvent of 1 part by mass of ethylene carbonate and 2 part by mass of methyl ethyl carbonate, in an amount of 1.0 mol/L of the electrolyte in the solvent.

As the negative electrode, usable here is one produced by integrating an alkali metal or alkaline metal-containing compound with a current-collecting material such as stainless steel-made net or the like. The alkali metal includes, for example, lithium, sodium, potassium, etc. The alkali metal-containing compound includes, for example, alloys of an alkali metal with aluminum, lead, indium, potassium, cadmium, tin, magnesium or the like; compounds of an alkali metal and a carbon material; compounds of a low-potential alkali metal and a metal oxide or sulfide, etc. In case where a carbon material is used as the negative electrode, the carbon material may be any one capable of being doped and dedoped with a lithium ion. For example, employable here are graphite, thermal cracked carbons, cokes, glassy carbons, fired bodies of organic polymer compounds, mesocarbon microbeads, carbon fibers, active carbons, etc.

The active material usable here for the positive electrode includes metal oxides such as lithium cobalt oxide, lithium nickel oxide, lithium manganese oxide, manganese dioxide, vanadium pentoxide, chromium oxide, etc.; metal sulfides such as molybdenum disulfide, etc. A mixture prepared by suitably adding a conductive assistant or a binder such as polytetrafluoroethylene or the like to the positive electrode active material is shaped into a shaped body with a core of a current-collecting material such as stainless steel-made net or the like, and the thus-shaped body is used here.

### EXAMPLES

With reference to Examples and Comparative Examples given hereinunder, the multilayer porous film of the present invention is described in more detail. However, the present invention is not limited to these. The lengthwise direction of the multilayer porous film is referred to as “longitudinal direction” and the direction vertical to the lengthwise direction is referred to as “lateral direction”.

### <Evaluation Methods>

### (1) Thermogravimetric Analysis

25 mg (referred to as W) of an alumina was sampled and heated from 25° C. at a heating rate of 10° C./min using a thermogravimetric analyzer (“Q5000IR” manufactured by TA Instrument Co., Ltd.), and the mass of the alumina at 250° C. W₂₅₀ and the mass thereof at 400° C. W₄₀₀ were measured. A value of (W₂₅₀−W₄₀₀)/W was then calculated.

### (2) Viscosity of Dispersion

Alumina, isopropyl alcohol and ion-exchanged water were mixed in the predetermined ratio as in Examples and Comparative Examples given below, and then processed in a bead mill under the given condition to prepare a dispersion. The viscosity of the dispersion was measured in one hour and 72 hours after preparation thereof, using a B-type viscometer (“TVB10H” manufactured by Toki Sangyo Co., Ltd.) at a peripheral speed of 100 rpm to be η₁ and η₇₂ (mPa·s), respectively.

### (3) Viscosity Stability of Dispersion

The viscosity stability of the dispersion was evaluated as follow.

G (good): The value of η₇₂/η₁ was less than 10.

N (not good): The value of η₇₂/η₁ was 10 or more.

### (4) Surface Smoothness (Degree of Roughness)

The degree of roughness was evaluated as follows. Using a microstructure analyzer (“ET4000A” manufactured by Kosaka Laboratory Ltd.), the surface on the coating layer side of the multilayer porous film was inspected in a viewing field of 300 μm×400 μm thereof, and the number of projections protruding from the periphery by 5 μm or more therein was counted. The surface smoothness was evaluated on the basis of the degree of roughness, according to the criteria mentioned below.

G (good): The degree of roughness was less than 100 projections/mm².

N (not good): The degree of roughness was 100 projections/mm² or more.

### (5) Total Thickness of Multilayer Porous Film

For the total thickness of the multilayer porous film, unspecified 5 points in the plane of the multilayer porous film were measured using a 1/1000 mm dial gauge, and the found data were averaged to give a mean value of the thickness of the film.

### (6) Thickness of Coating Layer

The thickness of the coating layer was calculated as the difference between the total thickness of the multilayer porous film on which the coating layer had been formed, and the thickness of the polyolefinic resin porous film.

### (7) Vapor Permeability Degree (Gurley Value)

The vapor permeability degree was measured according to JIS P8117 (2009).

### (8) Shrinkage at 150° C.

The multilayer porous film produced in each of Examples and Comparative Examples was cut out to have a size of 150 mm in length×10 mm in width, and was given two point marks at an interval of 100 mm in the lengthwise direction to prepare a sample. The sample was put into an oven (“Tabai Gear Oven GPH200” manufactured by Tabai Espec Co., Ltd.) set at 150° C. and statically left therein for 1 hour. The sample was taken out of the oven and cooled, and then the length between the two point marks was measured, and the shrinkage of the film was calculated according to the following equation.

Shrinkage (%)=100−(length after heating)

The above measurement was carried out both in the longitudinal direction and in the lateral direction of the multilayer porous film.

### (9) Heat Resistance

The heat resistance was evaluated according to the evaluation criteria mentioned below.

G (good): The shrinkage at 150° C. for 1 hour was less than 10% both in the longitudinal direction and in the lateral direction.

N (not good): The shrinkage at 150° C. for 1 hour was 10% or more in any of the longitudinal direction or the lateral direction.

### Examples, Comparative Examples

### Production of Polyolefinic Resin Porous Film

A polypropylenic resin (“Novatec PP FY6HA” manufactured by Japan Polypropylene Corporation, density: 0.90 g/cm³, MFR: 2.4 g/10 min), and a β-crystal nucleating agent 3,9-bis[4-(N-cyclohexylcarbamoyl)phenyl]-2,4,8,10-tetroxaspiro[5.5]undecane were prepared. These materials were blended in such a ratio that the amount of the β-crystal nucleating agent could be 0.2 parts by mass relative to 100 parts by mass of the polypropylenic resin, and put into a co-rotating twin-screw extruder (diameter: 40 mmφ, L/D: 32) manufactured by Toshiba Machine Co., Ltd., and melt-kneaded therein at a preset temperature of 300° C. The strands were cooled and solidified in a water bath and cut with a pelletizer into pellets of the starting materials.

The starting material pellets were put into an extruder, melted therein and extruded out through the T-die (nozzle), and cooled and solidified on a casting roll at 124° C. to form a film.

The film was stretched by 4.6 times in the longitudinal direction at 100° C., using a longitudinal stretcher, and thereafter stretched by 2.1 times in the lateral direction at 150° C., using a lateral stretcher, and then thermally fixed at 153° C. Subsequently, this was relaxed, and then, using a generator CP1 manufactured by VETAPHONE Co., Ltd., this was processed for corona surface treatment at an output of 0.4 kW and at a speed of 10 m/min to give a polyolefinic resin porous film.

### Example 1

An α-alumina (“LS-410” manufactured by Nippon Light Metal Company Ltd., mean particle size: 0.5 μm, specific surface area: 6.9 m²/g) was statically kept in a constant-temperature constant-humidity tank set at a temperature of 80° C. and at a relative humidity of 80%, for 3 days, then left cooled and taken out. In thermogravimetric analysis, the value of (W₂₅₀−W₄₀₀)/W of the thus-processed α-alumina was 0.00428.

52.6 parts by mass of the resultant α-alumina, 5.3 parts by mass of isopropyl alcohol and 42.1 parts by mass of ion-exchanged water were mixed, and processed in a bead mill to prepare a dispersion. The details of the condition of the bead mill used here are as follows.

Device: NVM-1.5 manufactured by AIMEX Corporation

Beads: made of φ0.5 mm zirconia, filling rate 85%

Peripheral speed: 10 m/sec

Discharge rate: 350 mL/min

The resultant dispersion was statically kept for 1 week, and then 61.8 parts by mass of the dispersion, 9.9 parts by mass of an aqueous solution of 5 mass % polyvinyl alcohol (“PVA-124” manufactured by Kuraray Co., Ltd.) and 28.3 parts by mass of ion-exchanged water were mixed, and hydrochloric acid was added thereto so that the acid could be 70 ppm by mass relative to the total amount of the dispersion to give a coating layer-forming dispersion having a solid concentration of 33% by mass.

The resultant coating layer-forming dispersion was applied onto the polyolefinic resin porous film, using a gravure roll (lattice pattern, number of lines: 25 lines/inch, depth: 290 μm, cell capacity 145 mL/m²), then dried in a drying furnace at 45° C. to form a coating layer, thereby producing a multilayer porous film.

The resultant multilayer porous film was evaluated, and the results were collected in Table 1.

### Example 2

An α-alumina that was on the same grade as that of the α-alumina used in Example 1 (“LS-410” manufactured by Nippon Light Metal Company Ltd.) but was from a different lot was statically kept in a constant-temperature constant-humidity tank set at a temperature of 80° C. and at a relative humidity of 80%, for 3 days, then left cooled and taken out. In thermogravimetric analysis, the value of (W₂₅₀−W₄₀₀)/W of the thus-processed α-alumina was 0.00390. Using the processed α-alumina and in the same manner as in Example 1, a multilayer porous film was produced.

The resultant multilayer porous film was evaluated, and the results were collected in Table 1.

### Comparative Example 1

A multilayer porous film was produced in the same manner as in Example 1 except that the α-alumina from the same lot as that of the α-alumina used in Example 1 was used without being kept in the constant-temperature constant-humidity tank. In thermogravimetric analysis, the value of (W₂₅₀−W₄₀₀)/W of the α-alumina was 0.00249.

The resultant multilayer porous film was evaluated, and the results were collected in Table 1.

### Comparative Example 2

A multilayer porous film was produced in the same manner as in Example 1 except that the α-alumina from the same lot as that of the α-alumina used in Example 2 was used without being kept in the constant-temperature constant-humidity tank. In thermogravimetric analysis, the value of (W₂₅₀−W₄₀₀)/W of the α-alumina was 0.00348.

The resultant multilayer porous film was evaluated, and the results were collected in Table 1.

### Comparative Example 3

The α-alumina from the same lot as that of the α-alumina used in Example 1 was used without being kept in the constant-temperature constant-humidity tank. In thermogravimetric analysis, the value of (W₂₅₀−W₄₀₀)/W of the α-alumina was 0.00249.

44.6 parts by mass of the α-alumina, 5.8 parts by mass of isopropyl alcohol and 49.6 parts by mass of ion-exchanged water were mixed, and then processed in a bead mill to prepare a dispersion. The details of the condition of the bead mill are as follows.

Device: NVM-L5 manufactured by AIMEX Corporation

Beads: made of φ0.5 mm zirconia, filling rate 85%

Peripheral speed: 10 m/sec

Discharge rate: 350 mL/min

The resultant dispersion was statically kept for 1 week, and then 72.8 parts by mass of the dispersion, 9.9 parts by mass of an aqueous solution of 5 mass % polyvinyl alcohol (“PVA-124” manufactured by Kuraray Co., Ltd.) and 17.3 parts by mass of ion-exchanged water were mixed, and hydrochloric acid was added thereto so that the acid could be 70 ppm by mass relative to the total amount of the dispersion to give a coating layer-forming dispersion having a solid concentration of 33% by mass.

In the same manner as in Example 1, the resultant coating layer-forming dispersion was applied onto the polyolefinic resin porous film and dried to form a coating layer, thereby producing a multilayer porous film.

The physical properties of the resultant multilayer porous film were evaluated, and the results were collected in Table 1.

### Comparative Example 4

The polyolefinic resin porous film alone was evaluated, and the results were collected in Table 1.

TABLE 1

| | | | | | Comparative | Comparative | Comparative | Comparative |
|---|---|---|---|---|---|---|---|---|
| | | | Example 1 | Example 2 | Example 1 | Example 2 | Example 3 | Example 4 |
| (W₂₅₀-W₄₀₀)/W | | — | 0.00428 | 0.00390 | 0.00249 | 0.00348 | 0.00249 | — |
| Viscosity of Dispersion after | | mPa · s | 227 | 67 | 13 | 71 | 10 | — |
| 1 hour (η₁) | | | | | | | | |
| Viscosity of Dispersion after | | mPa · s | 107 | 42 | 60000< | 60000< | 60000< | — |
| 72 hours (η₇₂) | | | | | | | | |
| Viscosity Stability of Dispersion | | — | G | G | N | N | N | — |
| Degree of Roughness | | projections/mm² | <100 | <100 | 250 | 333 | 333 | — |
| Surface Smoothness | | — | G | G | N | N | N | — |
| Total Thickness | | μm | 24 | 24 | 25 | 25 | 25 | 20 |
| Thickness of Coating Layer | | μm | 4 | 4 | 5 | 5 | 5 | 0 |
| Vapor Permeability | | sec/100 mL | 190 | 188 | 187 | 191 | 191 | 157 |
| Thermal | longitudinal direction | % | 4 | 4 | 4 | 4 | 5 | 13 |
| Shrinkage at | lateral direction | % | 5 | 4 | 5 | 5 | 4 | 12 |
| 150° C. | | | | | | | | |

| | | | | | | | |
|---|---|---|---|---|---|---|---|
| Heat Resistance | — | G | G | G | G | G | N |

As obvious from Table 1, the dispersions prepared in Examples 1 and 2 are excellent in viscosity stability. Since the coating layer was formed using the dispersion, there could be obtained multilayer porous films excellent in surface smoothness.

On the other hand, the multilayer porous films produced in Comparative Examples 1 and 2 had poor surface smoothness as compared with those in Examples since the viscosity stability of the dispersion used was poor.

Like that in Comparative Example 1, the multilayer porous film produced in Comparative Example 3 also had poor surface smoothness since the viscosity stability of the dispersion used was poor. Though the amount of water in the dispersion in Comparative Example 3 was larger than that in the dispersion in Example 1, the viscosity stability of the former dispersion was poor, which suggests that the viscosity stabilization effect of the dispersion is not caused merely by water absorption of alumina.

Since the polyolefinic resin porous film in Comparative Example 4 was not coated with a coating layer, the heat resistance of the film was insufficient.

The multilayer porous film of the present invention can be used in various applications that require vapor permeability characteristics. Concretely, the film can be extremely favorably used as a material for separators for lithium ion secondary batteries; pads for body fluid absorption such as disposable diapers, sanitary goods, etc., hygiene materials such as bed sheets, etc.; medical supply materials such as surgical gowns, hot pack substrates, etc.; clothing materials such as jackets, sportswear, rainwear, etc.; building materials such as wallpapers, roof waterproofing materials, heat insulating materials, acoustic absorbent materials, etc.; desiccants; moistureproof agents; deoxidants; disposable pocket warmers; wrapping and packaging materials for freshness-keeping wrapping or packaging, food wrapping or packaging, etc.

### REFERENCE SIGNS LIST

10 Separator for Nonaqueous Electrolyte Secondary Batteries
20 Secondary Battery
21 Positive Electrode Sheet
22 Negative Electrode Sheet
24 Positive Electrode Lead
25 Negative Electrode Lead
26 Gasket
27 Positive Electrode Cap

1. A multilayer porous film comprising
(i) a polyolefinic resin porous film, and
(ii) on at least one surface of the polyolefinic resin porous film, a coating layer comprising an alumina and a resin binder, wherein, when the alumina is heated at a heating rate of 10° C./min in thermogravimetric analysis, the mass of the alumina at 250° C., W₂₅₀, and the mass thereof at 400° C., W₄₀₀, satisfy the following relationship relative to the mass of the alumina at 25° C., W:
(W₂₅₀−W₄₀₀)/W≧0.00350,

2. The multilayer porous film according to claim 1, wherein a molar ratio of water molecules to aluminum oxide molecules in a crystal structure of the alumina, x in Al₂O₃.xH₂O, is less than 1.0.

3. The multilayer porous film according to claim 1, wherein the alumina is an α-alumina.

4. The multilayer porous film according to claim 1, wherein the resin binder is at least one selected from the group consisting of a polyvinyl alcohol, a polyvinylidene fluoride, a carboxymethyl cellulose, a polyacrylic acid and a polyacrylic acid derivative.

5. The multilayer porous film according to claim 1, wherein in the coating layer, the alumina content relative to the total amount of the alumina and the resin binder is within a range of from 80% by mass to 99.9% by mass.

6. The multilayer porous film according to claim 1, wherein the polyolefinic resin porous film comprises a polypropylenic resin.

7. The multilayer porous film according to claim 1, wherein the coating layer is formed on the polyolefinic resin porous film by applying a dispersion for forming the coating layer onto the film.

8. The multilayer porous film according to claim 7, wherein the dispersion medium for the dispersion for forming the coating layer is a mixed dispersion medium of water and a lower alcohol having from 1 to 4 carbon atoms.

9. A separator comprising the multilayer porous film of claim 1.

10. A nonaqueous electrolyte secondary battery comprising the separator of claim 9.
